(19) United States
(12) Patent Application Publication
(10) Pub. No.: US 2023/0067940 A1
(43) Pub. Date: Mar. 2, 2023

(54) VALVE ASSEMBLY FOR AN EXHAUST GAS RECIRCULATION SYSTEM

(71) Applicant: BorgWarner Inc., Auburn Hills, MI (US)

(72) Inventors: Sean McConnell, Livonia, MI (US); Martin P. Bogen, Rochester Hills, MI (US); Johannes Anton Preiss, Lake Orion, MI (US); Jeffery John Curtis, Oxford, MI (US); Nicolas Régent, Troy, MI (US); Christopher Lucas, Grand Blanc, MI (US)

(21) Appl. No.: 17/899,767

(22) Filed: Aug. 31, 2022

Related U.S. Application Data
(60) Provisional application No. 63/239,136, filed on Aug. 31, 2021.
(60) Provisional application No. 63/239,156, filed on Aug. 31, 2021.

(51) Int. Cl. F02M 26/72; F02M 26/68; F02M 26/21; F02M 26/16; F02M 26/51; F02M 26/39

(52) U.S. Cl. CPC F02M 26/72; F02M 26/16; F02M 26/21; F02M 26/39; F02M 26/51; F02M 26/68

(57) ABSTRACT

A valve assembly for an exhaust gas recirculation system includes a housing defining an inlet bore and including a second interior surface defining a housing bore. The valve assembly also includes a valve seat and a valve. The valve includes a valve stem and a valve sealing member. The valve assembly optionally includes a baffle at least partially disposed in the housing bore. A first interior radius is defined between the valve stem and the second interior surface. A second interior radius is defined between at least one of the valve stem and the second interior surface, the valve stem and the baffle, and the baffle and the second interior surface. The second interior radius is different from the first interior radius and is configured to direct the flow of the exhaust gas in the housing bore to reduce swirl of exhaust gas in the housing bore.

### CROSS-REFERENCE TO RELATED APPLICATIONS

The present application claims priority to and all the benefits of U.S. Provisional Pat. Application Nos. 63/239,136 and 63/239,156 both filed Aug. 31, 2021, the disclosures of which are expressly hereby incorporated herein by reference in their entirety.

### BACKGROUND OF THE INVENTION

### 1. Field of the Disclosure

The present disclosure generally relates to an exhaust gas recirculation system and, more specifically, to a valve assembly for an exhaust gas recirculation system.

### 2. Description of the Related Art

Conventional valve assemblies in the art for exhaust gas recirculation systems include a housing having a first interior surface defining an inlet bore extending along an inlet axis, a second interior surface defining a housing bore extending along a housing axis that is perpendicularly oriented with respect to the inlet axis, and a third interior surface defining an outlet bore extending along an outlet axis. The inlet bore receives exhaust gas from an internal combustion engine. The housing bore is fluidly coupled to the inlet bore for receiving exhaust gas from the inlet bore, and the outlet bore is fluidly coupled to the housing bore for discharging exhaust gas from the housing bore. Typical valve assemblies further include a valve seat disposed in the housing bore. Typical valve assemblies further include a valve including a valve stem and a valve sealing member. The valve is moveable along the housing axis between a first position for allowing exhaust gas to flow from the inlet bore through the housing bore and into the outlet bore, and a second position for restricting exhaust gas flow from the inlet bore through the housing bore and into the outlet bore.

However, typical valve assemblies are unable to reduce swirl of the exhaust gas entering the housing bore. Increased swirl of exhaust gas causes greater pressure drop of exhaust gas throughout the valve assembly and reduced flow of the exhaust gas, which decreases performance of the internal combustion engine due to inconsistent flow of exhaust gas through the exhaust gas recirculation system.

As such, there remains a need to provide an improved valve assembly for an exhaust gas recirculation system.

### SUMMARY OF THE INVENTION

A valve assembly for an exhaust gas recirculation system of an internal combustion engine includes a housing including a first interior surface defining an inlet bore extending along an inlet axis. The inlet bore is configured to receive exhaust gas from the internal combustion engine. The housing also includes a second interior surface defining a housing bore extending along a housing axis that is perpendicularly oriented with respect to the inlet axis. The housing bore is fluidly coupled to the inlet bore for receiving the exhaust gas from said inlet bore. The housing further includes a third interior surface defining an outlet bore extending along an outlet axis. The outlet bore is fluidly coupled to the housing bore for discharging exhaust gas from the housing bore. The valve assembly also includes a valve seat disposed in the housing bore, and a valve disposed in the housing bore. The valve includes a valve stem extending along the housing axis and a valve sealing member coupled to and moveable with the valve stem along the housing axis. The valve is movable along the housing axis in the housing bore between a first position for allowing exhaust gas to flow from the inlet bore through the housing bore and into the outlet bore, and a second position different from the first position for restricting exhaust gas flow from the inlet bore through the housing bore and into the outlet bore. The valve assembly optionally includes a baffle at least partially disposed in the housing bore. A first interior radius is defined between the valve stem and the second interior surface. A second interior radius is defined between at least one of the valve stem and the second interior surface, the valve stem and the baffle, and the baffle and the second interior surface. The second interior radius is different from the first interior radius and is configured to direct the flow of the exhaust gas in the housing bore to reduce swirl of exhaust gas in the housing bore.

### BRIEF DESCRIPTION OF THE DRAWINGS

Other advantages of the present invention will be readily appreciated, as the same becomes better understood by reference to the following detailed description when considered in connection with the accompanying drawings.

FIG. 1 is a perspective view of a valve assembly of an exhaust gas recirculation system, with the valve assembly including a housing.

FIG. 2 is a perspective view of the valve assembly of FIG. 1 with a portion of the housing shown in cross-section, with the valve assembly also including a valve seat and a valve.

FIG. 3 is a cross-sectional view of the valve assembly of FIG. 1, with the valve of the valve assembly including a valve stem and a valve sealing member coupled to and moveable with the valve stem along, and with the valve being in a first position for allowing exhaust gas to flow from an inlet bore defined by the housing, through a housing bore defined by the housing, and into an outlet bore defined by the housing.

FIG. 4 is a cross-sectional view of the valve assembly of FIG. 1, with the valve of the valve assembly being in a second position different from the first position where the valve sealing member restricts exhaust gas flow from the inlet bore through the housing bore and into the outlet bore.

FIG. 5 is a cross-sectional view of the valve assembly of FIG. 1.

FIG. 6 is a side cross-sectional view of one embodiment of the valve assembly, with the valve assembly including a baffle.

FIG. 7 is a top cross-sectional view of the valve assembly of FIG. 6, with a first interior radius defined between the valve stem and a second interior surface of the housing, a second interior radius defined between the baffle and the second interior surface, with the second interior radius being less than the first interior radius.

FIG. 8 is a perspective view of one embodiment of the baffle.

FIG. 9 is cross-sectional view of the valve housing.

FIG. 10 is a perspective view of a flow path of exhaust gas through the valve housing without a baffle, with the red portion of the exhaust flow indicating higher velocity of the exhaust gas.

FIG. 11 is a perspective view of a flow path of exhaust gas through the valve housing with a baffle, with the green portion of the exhaust flow indicating lower swirl of exhaust gas.

FIG. 12 is a graph comparing pressure drop through the valve assembly with and without a baffle.

FIG. 13 is top cross-sectional view of another embodiment of the valve assembly and baffle, with the second interior radius being defined between the valve stem and the baffle, and with the valve assembly including a second baffle and a third baffle.

FIG. 14 is a side cross-sectional view of the valve assembly of FIG. 13.

FIG. 15 is a side cross-sectional view of another embodiment of the valve assembly.

FIG. 16 is a top cross-sectional view of the valve assembly of FIG. 15.

FIG. 17 is a perspective cross-sectional view of another embodiment of the valve assembly and the baffle, with the baffle being coupled to and extending from the valve seat.

FIG. 18 is a perspective view of the valve seat and baffle of FIG. 17, and further including a second baffle coupled to and extending from the valve seat.

FIG. 19 is a top cross-sectional view of another embodiment of the valve assembly and the baffle, with the baffle including a base portion coupled to the housing, and a first baffle arm and a second baffle arm extending from the base portion toward the valve stem.

FIG. 20A is a top cross-sectional view of another embodiment of the valve assembly, with the baffle coupled to and extending from the valve stem toward the second interior surface, with the valve assembly also including the second baffle with the second baffle being coupled to the second interior surface and extending toward the valve stem, and with the first and second baffles overlapping one another with respect to the valve stem.

FIG. 20B is a top cross-sectional view of another embodiment of the valve assembly, with the baffle coupled to and extending from the valve stem toward the second interior surface, with the valve assembly also including the second baffle with the second baffle being coupled to the second interior surface and extending toward the valve stem, and with the first and second baffles being spaced from one another with respect to the valve stem.

FIG. 21 is a perspective view of another embodiment of the valve assembly and the baffle, with the baffle being coupled to the valve stem and extending from the valve stem toward the second interior surface, with the second interior radius being defined between the baffle and the second interior surface, and with the baffle including a first and second stem arms extending from the valve stem toward the second interior surface.

FIG. 22 is a perspective view of another embodiment of the valve assembly and the baffle of FIG. 21, with the first and second stem arms being circumferentially spaced 90 degrees from one another about the valve stem.

FIG. 23 is a perspective view of another embodiment of the valve assembly and baffle of FIG. 21, with the baffle further including third and fourth stem arms extending from the valve stem toward the second interior surface.

FIG. 24 is a cross-sectional view of another embodiment of the valve assembly and the baffle, with the baffle coupled to and extending from the valve stem toward the second interior surface, with the valve assembly also including the second baffle with the second baffle being coupled to the second interior surface and extending toward the valve stem.

FIG. 25 is a side cross-sectional view of another embodiment of the valve assembly and the baffle, with the valve assembly including a valve projection extending from the valve sealing member into the housing bore.

FIG. 26 is a top cross-sectional view of another embodiment of the valve assembly and the baffle, with the housing defining a baffle channel, and with a base arm of the baffle being disposed in the baffle channel.

FIG. 27 is a top cross-sectional view of the valve assembly, with the second interior radius being greater than the first interior radius, with the second interior surface defining a first depression and a second depression spaced circumferentially from one another about the valve stem, and with the first and second depressions defining the second interior radius being greater than the first interior radius.

FIG. 28 is an illustration of one embodiment of the second interior surface of the valve assembly of FIG. 27, with second interior surface defining the first depression and second depression including a plurality of contours.

FIG. 29A is side cross-sectional view of another embodiment of the valve assembly and the baffle.

FIG. 29B is a side cross-sectional view of another embodiment of the valve assembly and baffle.

FIG. 29C is a top cross-sectional view of the valve assembly and baffle of FIG. 29B.

### DETAILED DESCRIPTION OF THE INVENTION

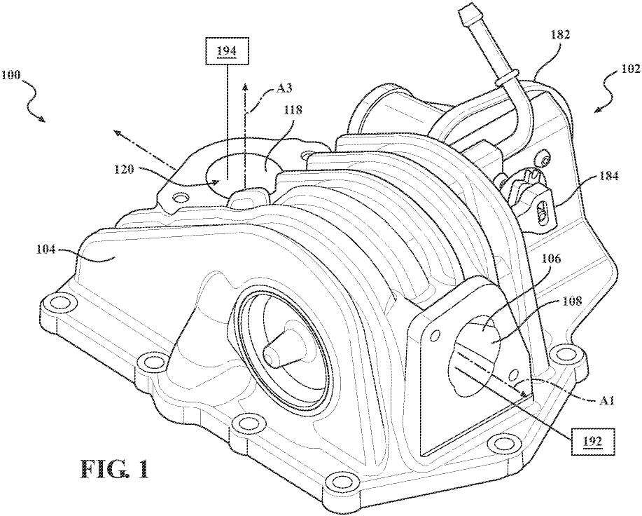

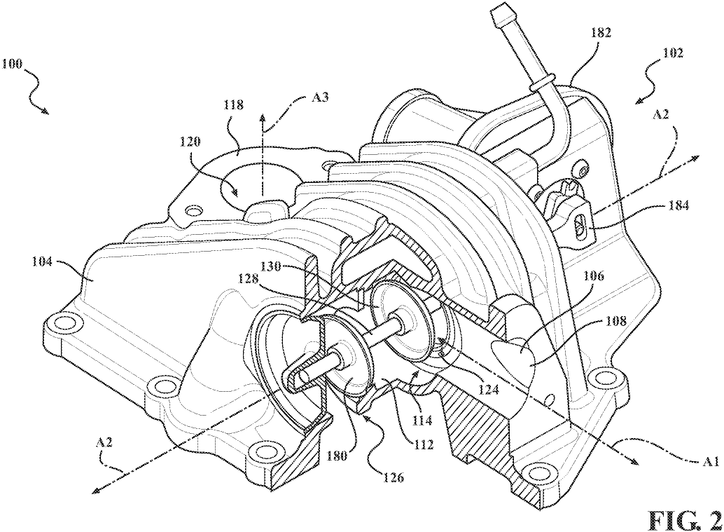

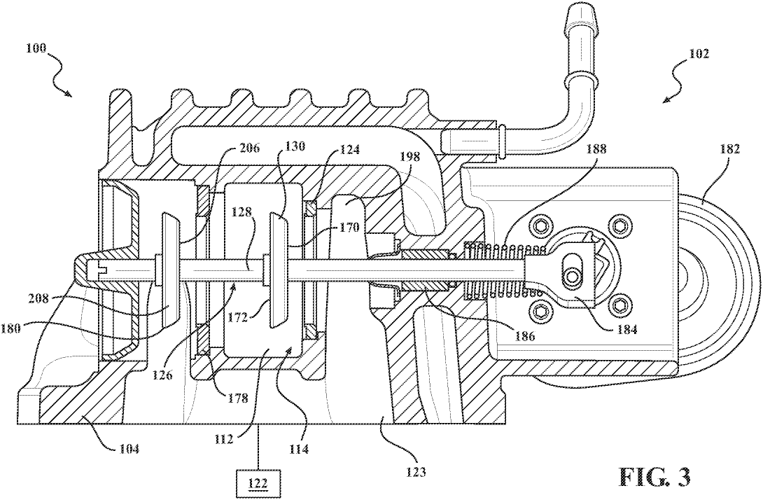

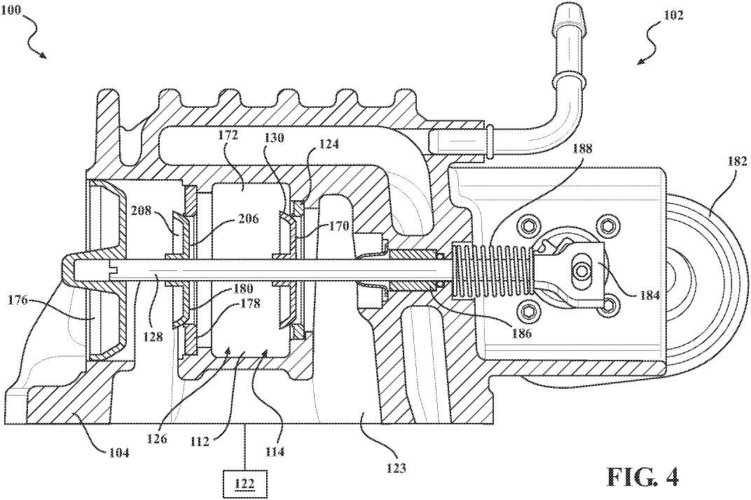

With reference to the Figures, wherein like numerals indicate like parts throughout the several views, a valve assembly 100 for an exhaust gas recirculation system 102 of an internal combustion engine is generally shown in FIGS. 1-5. As shown in FIG. 1, the exhaust gas recirculation system 102 may include an intake manifold 192 coupled to the housing 104 and fluidly coupled to the inlet bore 108 for delivering exhaust gas from the internal combustion engine, and an exhaust manifold 194 coupled to the housing 104. The valve assembly 100 includes a housing 104 including a first interior surface 106 defining an inlet bore 108 extending along an inlet axis A1. The inlet bore 108 is configured to receive exhaust gas from the internal combustion engine. The housing 104 also includes a second interior surface 112 defining a housing bore 114 extending along a housing axis A2 that is perpendicularly oriented with respect to the inlet axis A1. The housing bore 114 is fluidly coupled to the inlet bore 108 for receiving the exhaust gas from the inlet bore 108. The housing 104 further includes a third interior surface 118 defining an outlet bore 120 extending along an outlet axis A3. The outlet bore 120 is fluidly coupled to the housing bore 114 for discharging exhaust gas from the housing bore 114 into the exhaust manifold 194 and into the internal combustion engine. Specifically, the valve assembly 100 typically includes a cooler 122 for cooling the exhaust gas and for fluidly coupling the housing bore 114 and the outlet bore 120. The cooler 122 is fed through a transitional cavity 123, which may have a U-shape, defined by the housing 104, as best shown in FIGS. 3 and 4. The valve assembly 100 also includes a valve seat 124 disposed in the housing bore 114. The valve seat 124 may be integral with the housing 104 (i.e., one-piece) or may be a separate component from the housing 104 (i.e., two-pieces).

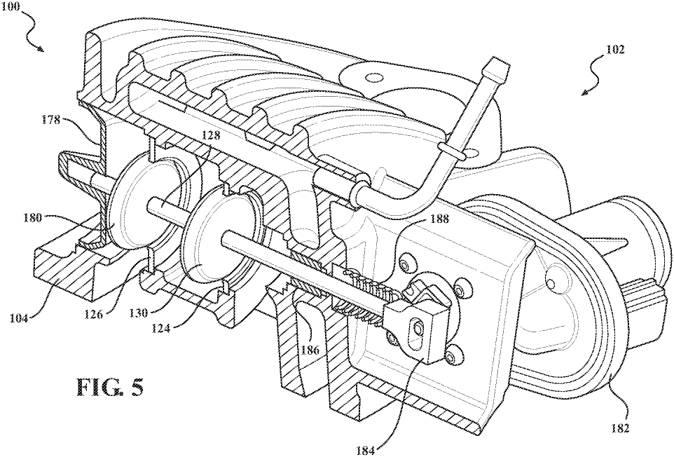

The valve assembly 100 additionally includes a valve 126 disposed in the housing bore 114. The valve 126 includes a valve stem 128 extending along the housing axis A2 and a valve sealing member 130 coupled to and moveable with the valve stem 128 along the housing axis A2. The valve 126 is movable along the housing axis A2 in the housing bore 114 between a first position for allowing exhaust gas to flow from the inlet bore 108 through the housing bore 114 and into the outlet bore 120, and a second position for restricting exhaust gas flow from the inlet bore 108 through the housing bore 114 and into the outlet bore 120. For example, in the first position, the valve sealing member 130 is disengaged and spaced from the valve seat. In the second position, the valve sealing member 130 is closer to the valve seat 124 than when in the first position. When in the second position, the valve sealing member 130 may be adjacent to and spaced from the valve seat 124 to restrict exhaust gas flow, or the valve sealing member 130 may be engaged with the valve seat 124 to also restrict exhaust gas flow. The valve assembly 100 may include an actuator 182 coupled to the housing 104 and coupled to the valve stem 128 for moving the valve 126 between the first and second positions. The valve assembly 100 may also include, as best shown in FIG. 5, a stem link 184 coupling the actuator 182 to the valve stem 128, a stem bushing 186 coupled to the housing 104 for aligning the valve stem 128 and for sealing the housing bore 114, and a stem spring 188 for biasing against the stem link 184.

With reference to FIG. 4, the valve sealing member 130 may have a first valve member surface 170 facing and optionally engageable with the valve seat 124, and a second valve member surface 172 facing away from the first valve member surface 170. The second valve member surface 172 may define a valve depression 173 with respect to the valve stem 128. The valve 126 may be further defined as a poppet valve and may further include a second valve sealing member 180 coupled to the valve stem 128 and spaced axially from the first valve sealing member 130 with respect to the valve stem 128. The valve assembly 100 may include a second valve seat 178 spaced from the first valve seat 124 along the housing axis A2, with the second valve sealing member 180 being disengaged from the second valve seat 178 when the valve 126 is in the first position, and with the second valve sealing member 180 being engaged with or adjacent to and spaced from (i.e., closer to the second valve seat 178 when in the second position than when in the first position) the second valve seat 178 when the valve 126 is in the second position. Typically, the first valve seat 124 and the second valve seat 178 face away from one another with respect to the valve stem 128. Said differently, the first valve seat 124 faces the housing bore 114 with respect to the valve stem 128, and the second valve seat 178 faces away from the housing bore 114 with respect to the valve stem 128. The second valve sealing member 180 may have a third valve member surface 206 facing and optionally engageable with the second valve seat 178, and a fourth valve member surface 208 facing away from the third valve member surface 206 with respect to the housing axis A2. The fourth valve member surface 208 may define a second valve depression 176.

When the valve 126 moves between the first and second positions, the first valve sealing member 130 is moveable within the housing bore 114 the second valve sealing member 180 is disposed outside of the housing bore 114. The housing bore 114 may be defined as being between the valve seat 124 and the second valve seat 178 along the housing axis A2. In some embodiments, the housing bore 114 is further defined as being the cylindrical portion defined by the second interior surface 112.

In one embodiment, the valve assembly 100 optionally includes a baffle 132 at least partially disposed in the housing bore 114.

A first interior radius R1 may be defined between the valve stem 128 and the second interior surface 112, and a second interior radius R2 may be defined between at least one of the valve stem 128 and the second interior surface 112, the valve stem 128 and the baffle 132, and the baffle 132 and the second interior surface 112. The second interior radius R2 may be different from the first interior radius R1 and configured to direct the flow of the exhaust gas in the housing bore 114 to reduce swirl of exhaust gas in the housing bore. In other words, the second interior surface 112 defining the housing bore 114 is non-circular. In one embodiment, the second interior radius R2 is less than the first interior radius R1, as described in further detail below. In such embodiments, a ratio of the second interior radius R2 to the first interior radius R1 may be between .1 to 1 and .9 to 1. In one embodiment, the ratio of the second interior radius R2 to the first interior radius R1 is 0.9 to 1. In one embodiment, the ratio of the second interior radius R2 to the first interior radius R1 is 0.8 to 1. In one embodiment, the ratio of the second interior radius R2 to the first interior radius R1 is 0.7 to 1. In one embodiment, the ratio of the second interior radius R2 to the first interior radius R1 is 0.6 to 1. In one embodiment, the ratio of the second interior radius R2 to the first interior radius R1 is 0.5 to 1. In one embodiment, the ratio of the second interior radius R2 to the first interior radius R1 is 0.4 to 1. In one embodiment, the ratio of the second interior radius R2 to the first interior radius R1 is 0.3 to 1. In one embodiment, the ratio of the second interior radius R2 to the first interior radius R1 is 0.2 to 1. In one embodiment, the ratio of the second interior radius R2 to the first interior radius R1 is 0.1 to 1. In one embodiment, the ratio of the second interior radius R2 to the first interior radius R1 is 0.66 to 1.

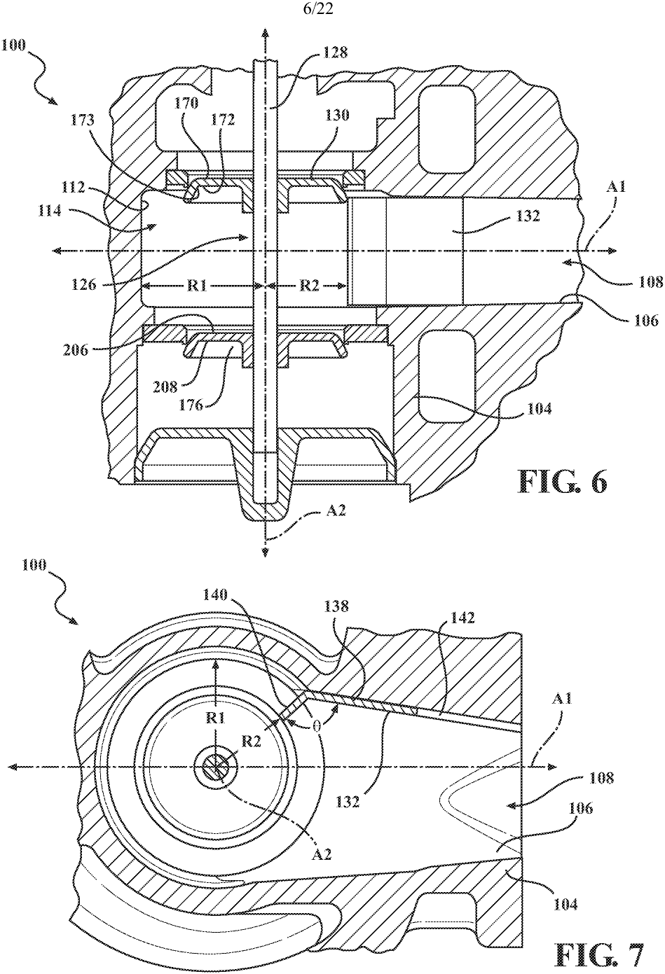

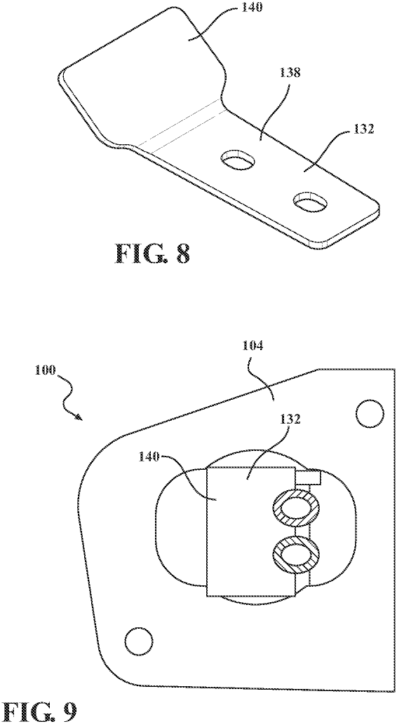

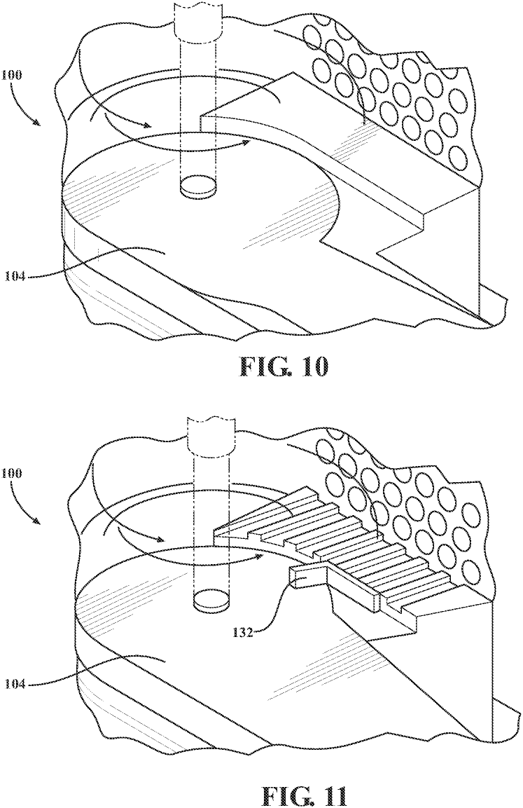

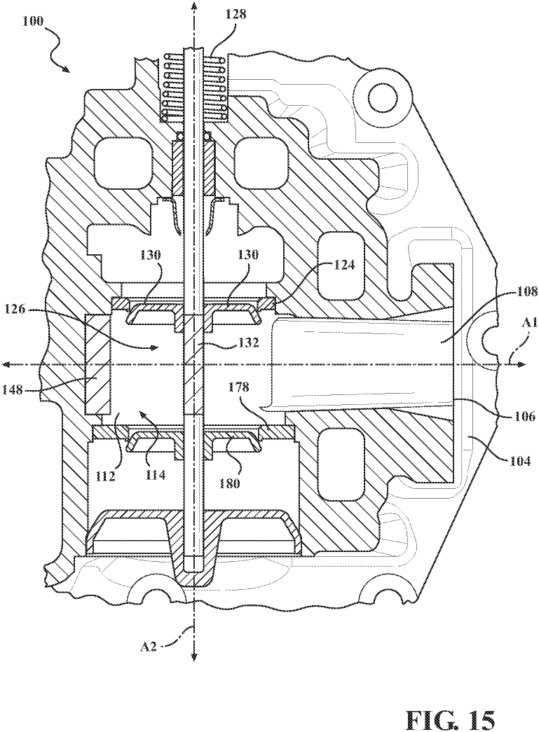

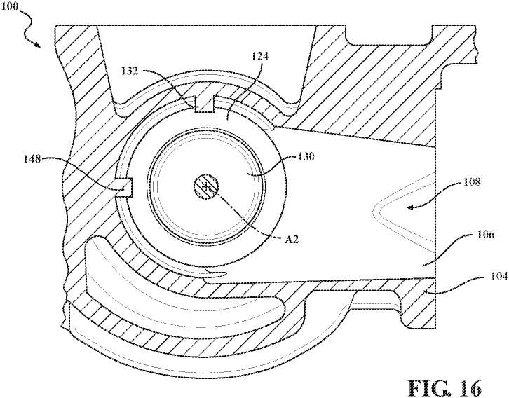

As shown in FIGS. 6-11, 13-19, 25, 26, and 29A-29C, the valve assembly 100 may include a baffle 132. In such embodiments, the second interior radius R2 may be defined between the valve stem 128 and the baffle 132. It is to be appreciated that the baffle 132 may be integral with the housing 104 (i.e., one-piece), or that the baffle 132 may be a separate component from the housing 104 (i.e., two-pieces). It is to be appreciated, as described in further detail below, that the valve assembly 100 may include more than one baffle, such as a second, third, and fourth baffle.

As shown in FIGS. 6-9, 11, 25, 26, and 29A-29C, the baffle 132 may include a base arm 138 coupled to the housing 104, for example coupled to the first interior surface 106 of the housing 104, and a projecting arm 140 extending into the housing bore 114. The base arm 138 may be disposed in the inlet bore 108 and the projecting arm 140 may be disposed in the housing bore 114. In such embodiments, the second interior radius R2 is defined between the valve stem 128 and the projecting arm 140. Although not explicitly shown in the FIGS., it is to be appreciated that the projecting arm 140 may define a plurality of holes for directing exhaust flow to reduce swirl in the housing bore 114. The projecting arm 140 may extend toward the valve stem 128.

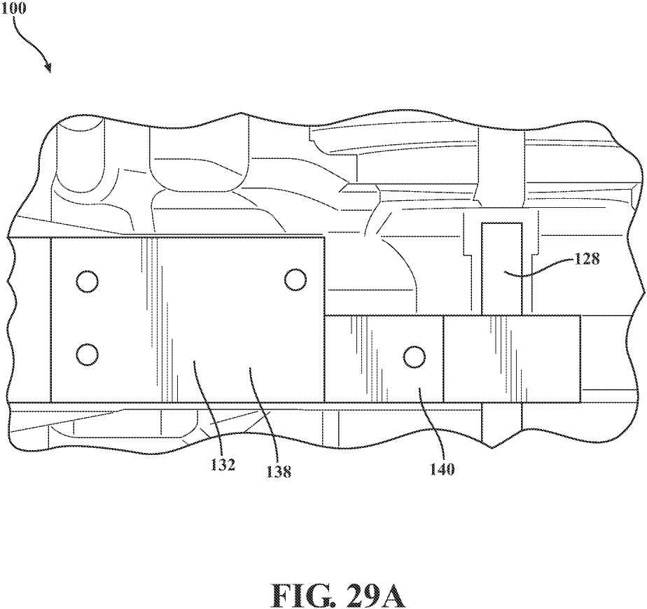

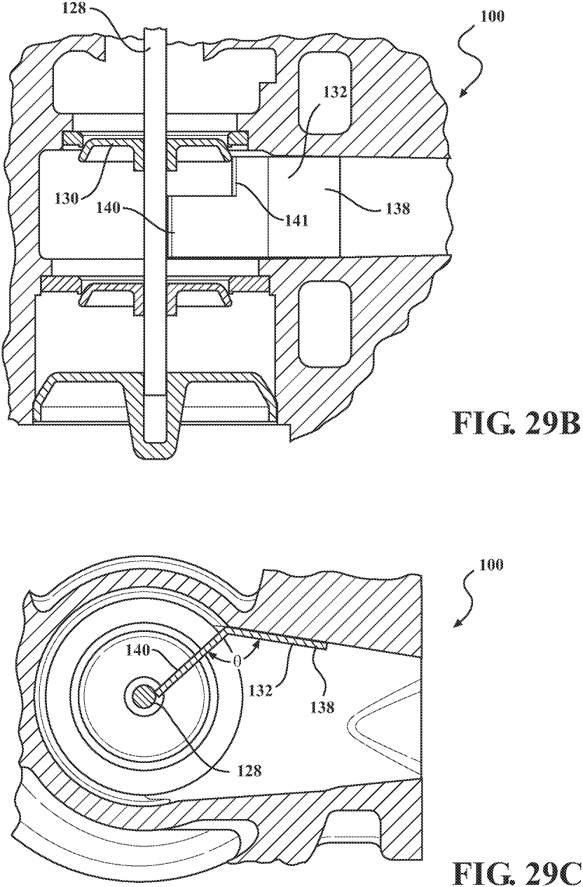

Typically, the projecting arm 140 extends orthogonally from the base arm 138. In such embodiments, the projecting arm 140 may extend at an angle θ between 120 and 180 degrees from the base arm 138. The projecting arm 140 may be at an angle that is 90 degrees from the flow of the exhaust gas. In other words, the projecting arm 140 may be oriented such that the flow of exhaust gas perpendicularly engages the projecting arm 140. The projecting arm 140, as shown in FIGS. 29B and 29C, may define an arm cutout 141 with respect to the valve stem 128. The valve sealing member 130, when moving between the first and second positions of the valve 126, may move within the arm cutout 141.

The base arm 138 may be disposed in the inlet bore 108 and the projecting arm 140 may be disposed in the housing bore 114, as shown in FIGS. 6, 7, 25, 26, and 29A-29C. With reference in particular to FIGS. 7 and 26, the first interior surface 106 of the housing 104 may define a baffle channel 142, and the base arm 138 of the baffle 132 may be disposed in the baffle channel 142 for coupling the baffle 132 to the housing 104. In other embodiments, the baffle 132 may be welded to the housing 104 or fastened to the housing 104, such as through rivets, bolts, screws, or the like.

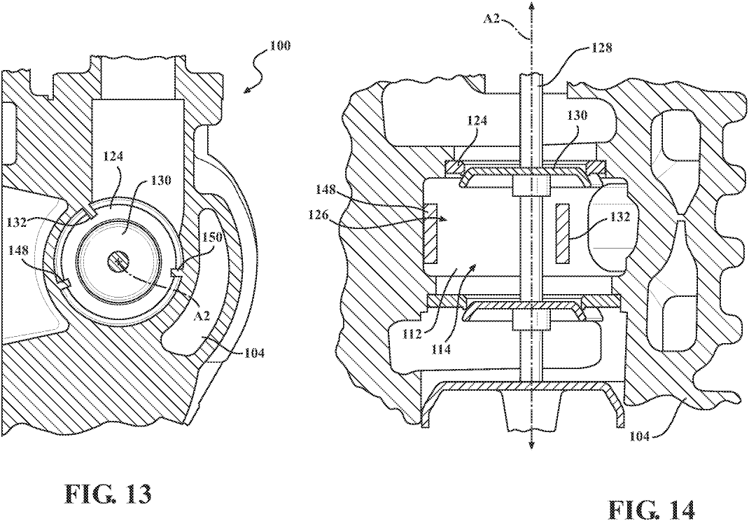

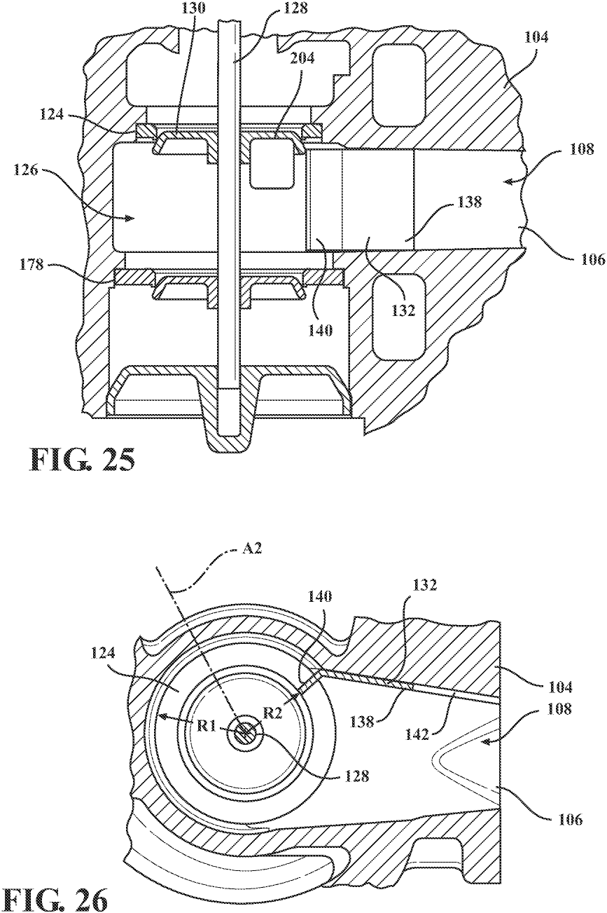

In one embodiment, as shown in FIGS. 13-25, the baffle 132 may be disposed in the housing bore 114. In such embodiments, the baffle 132 may be a separate component (i.e., two-pieces) from the housing 104 or may be integral with the housing 104 (i.e., one-piece). When the baffle 132 is disposed in the housing bore 114, the second interior radius R2 is defined between the valve stem 128 and the baffle 132. When the baffle 132 is integral with the housing 104, the baffle 132 extends toward the valve stem 128 from the second interior surface 112 to define the second interior radius R2. When the baffle 132 is integral with the housing 104, the baffle 132 may be cast into the housing 104. In one embodiment, as shown in FIG. 25, the valve assembly 100 includes a valve projection 204 extending from the valve sealing member 130 into the housing bore 114.

As shown in FIGS. 13-16, the valve assembly 100 may further include a second baffle 148 disposed in the housing bore 114 and circumferentially spaced from the baffle 132 about the valve stem 128. The baffle 132 and second baffle 148 are angularly offset from one another. The baffle 132 and second baffle 148 may be angularly offset by any suitable angle, such as 200 degrees, 180 degrees, 160 degrees, 140 degrees, 120 degrees, 100 degrees, 80 degrees, 60 degrees, or 45 degrees about the valve stem 128. With continued reference to FIGS. 13-16, the valve assembly 100 may further include a third baffle 150 disposed in the housing bore 114, with the baffle 132, second baffle 148, and third baffle 150 being circumferentially spaced from one another about the valve stem 128. The baffle 132, second baffle 148, and third baffle 150 may be angularly offset from one another, for example by 100 degrees, 90 degrees, 75 degrees, 60 degrees, or 45 degrees about the valve stem 128. It is to be appreciated that the valve assembly 100 may include more than three baffles, and it is to also be appreciated that the baffle 132, second baffle 148, and third baffle 150 may be integral with the valve housing 104 or may be a separate component from the valve housing 104.

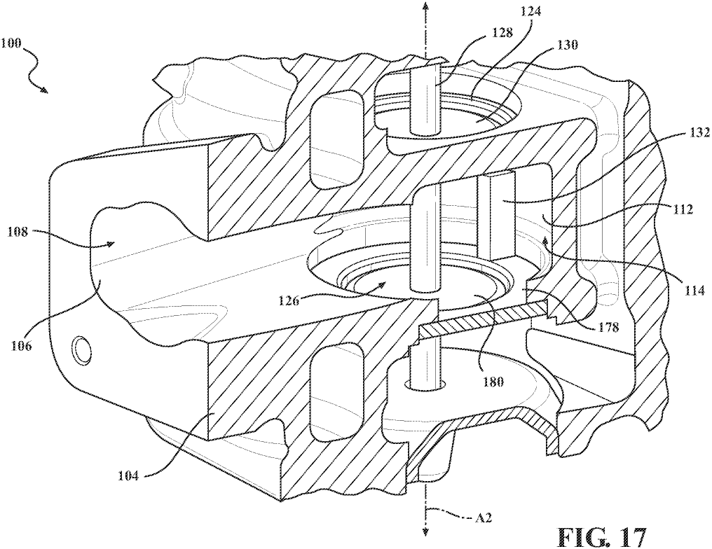

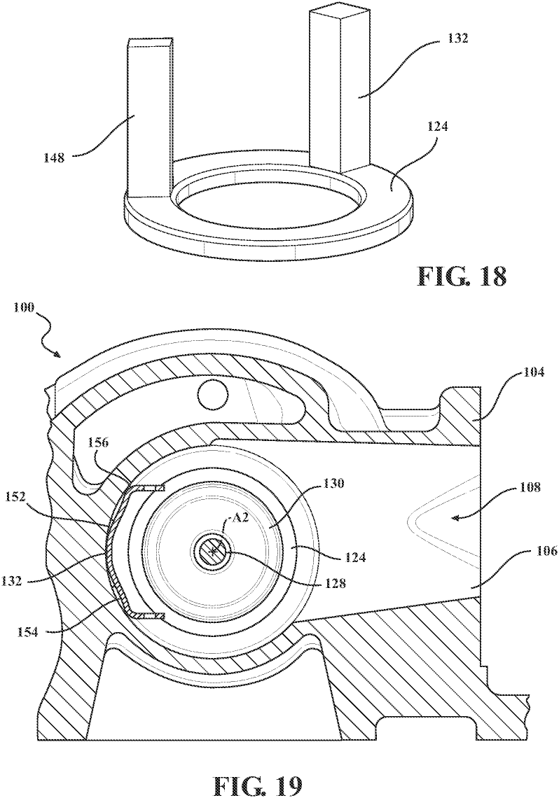

As shown in FIGS. 17 and 18, the baffle 132 is coupled to and extends from the valve seat 124 in the housing bore 114. In such embodiments, the baffle 132 may be integral with the valve seat 124 (i.e., one-piece) or may be a separate component from the valve seat 124 (i.e., two-pieces). The valve assembly 100 may include the second baffle 148 coupled to and extending from the valve seat 124 in the housing bore 114 and circumferentially spaced from the baffle 132 about the valve stem 128. The baffle 132 and second baffle 148 are angularly offset from one another. The baffle 132 and second baffle 148 may be angularly offset by any suitable angle, such as 200 degrees, 180 degrees, 160 degrees, 140 degrees, 120 degrees, 100 degrees, 80 degrees, 60 degrees, or 45 degrees about the valve stem 12. Although not explicitly shown in FIGS. 17 and 18, the valve assembly may include a third baffle 150, with baffle 132, second baffle 148, and third baffle 150 being circumferentially spaced from one another about the valve stem 128. The baffle 132, second baffle 148, and third baffle 150 may be angularly offset from one another, for example by 100 degrees, 90 degrees, 75 degrees, 60 degrees, or 45 degrees about the valve stem 128. It is to be appreciated that the valve assembly 100 may include more than three baffles, and it is to also be appreciated that the baffle 132, second baffle 148, and third baffle 150 may be integral with the valve housing 104 or may be a separate component from the valve housing 104. It is to be appreciated that the baffles shown in FIGS. 13-16 may be combined with the baffles shown in FIGS. 17 and 18.

With reference to FIG. 19, another embodiment of the baffle 132 is shown. In this embodiment, the baffle 132 includes a base portion 152 coupled to the second interior surface 112, and a first baffle arm 154 and a second baffle arm 156 extending from the base portion 152 toward the valve stem 128. As shown in FIG. 19, the base portion 152, first baffle arm 154, and second baffle arm 156 have a U-shaped configuration with respect to the valve stem 128. The base portion 152 of the baffle 132 may be laser welded or clipped into a casting feature defined by the second interior surface 112 of the valve housing 104. The baffle in FIG. 19 may be stamped to form any suitable configuration, such as the U-shape shown in FIG. 19. The first baffle arm 154 and the second baffle arm 156 may define holes for allowing a portion of the exhaust gas to flow through the first baffle arm 154 and the second baffle arm 156, which allows some exhaust gas to flow but disrupts swirling of the exhaust gas in the housing bore 114. The first baffle arm 154 and second baffle arm 156 may have corrugations, raised dimples, expanded mesh, dual-fin, or a trapezoid configuration.

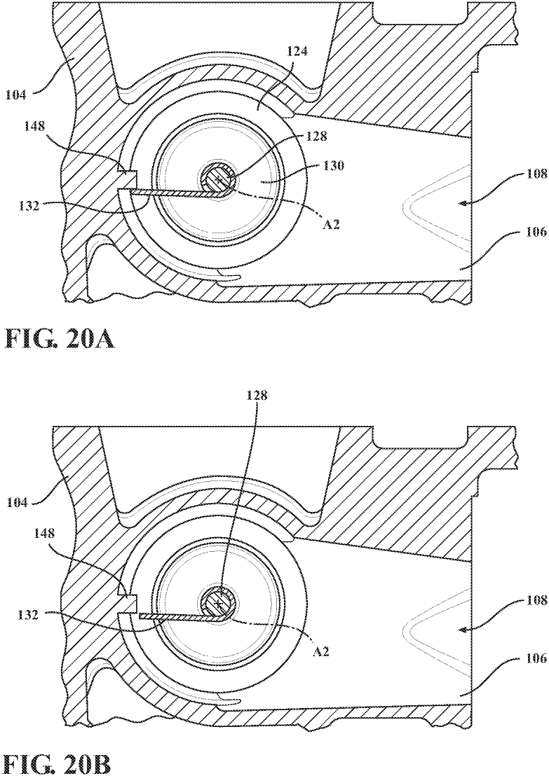

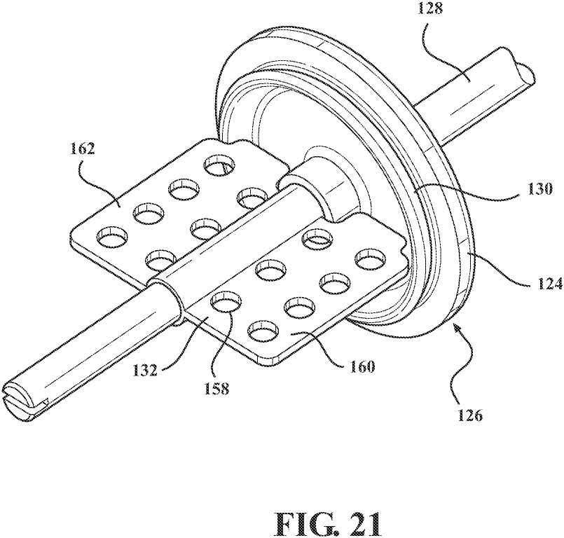

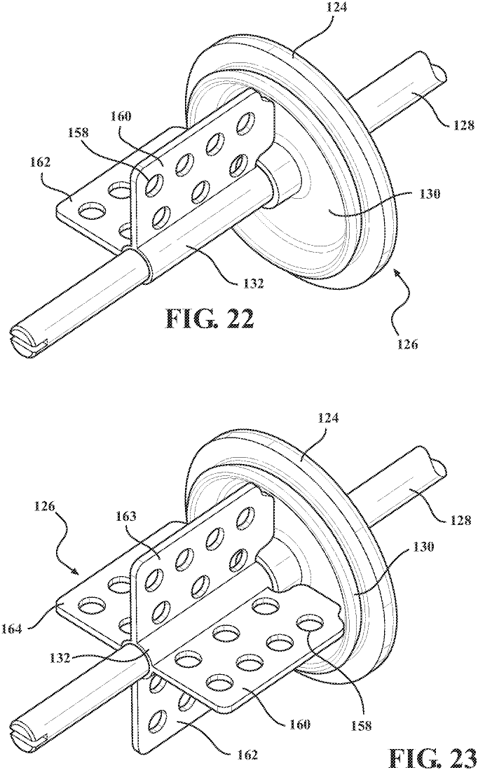

In another embodiment, as shown in FIG. 20A-24, the baffle 132 is coupled to the valve stem 128 and extends from the valve stem 128 toward the second interior surface 112. In such embodiments, the second interior radius R2 is defined between the baffle 132 and the second interior surface 112. With reference to FIGS. 21 and 22, the baffle 132 may include a first stem arm 160 and a second stem arm 162 extending from the valve stem 128 toward the second interior surface 112. As shown in FIG. 21, the first valve stem 128 and the second valve stem 128 of the baffle 132 are circumferentially spaced 180 degrees from one another about the valve stem 128. The first valve stem 128 and the second valve stem 128 may be angularly spaced from one another at any suitable angle, such as 90 degrees, as shown in FIG. 22. As shown in FIGS. 21-23, the first stem arm 160 and second stem arm 162 of the baffle 132 may define a plurality of holes 158. It is to be appreciated that the baffle 132 may have more than the first stem arm 160 and the second stem arm 162, such as a third stem arm 163, and a fourth stem arm 164 as shown in FIG. 23. In the embodiment shown in FIG. 23, the first stem arm 160, second stem arm 162, third stem arm 163, and fourth stem arm 164 are circumferentially spaced 90 degrees from one another about the valve stem 128. The first stem arm 160, second stem arm 162, third stem arm 163, and fourth stem arm 164 may define the plurality of holes 158. The stem arms may be fastened to the valve stem 128 in any suitable manner, such as welding and fastening.

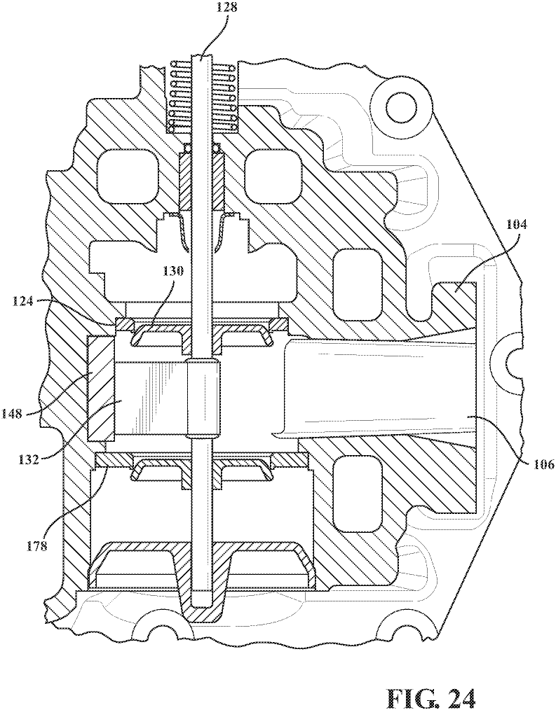

With reference to FIGS. 20A, 20B, and 24, the valve assembly 100 may include the second baffle 148. In such embodiments, the baffle 132 extends from the valve stem 128 toward the second interior surface 112, and the second baffle 148 extends from the second interior surface 112 toward the valve stem 128. As shown in FIG. 20A, the baffle 132 and the second baffle 148 may overlap one another with respect to the valve stem 128. In other words, the baffle 132 may extend past the second baffle 148 when extending toward the second interior surface 112. As shown in FIG. 20B, the baffle 132 and the second baffle 148 may defined a space between one another with respect to the valve stem 128. It is to be appreciated that the baffle 132 shown in FIGS. 20A and 20B may include any number of stem arms, such as the first stem arm 160, second stem arm 162, third stem arm 163, and/or fourth stem arm 164 as shown in FIGS. 21-23. It is also to be appreciated that the second baffle 148 may include multiple baffles extending from the second interior surface 112 toward the valve stem 128, as shown in FIGS. 13-16.

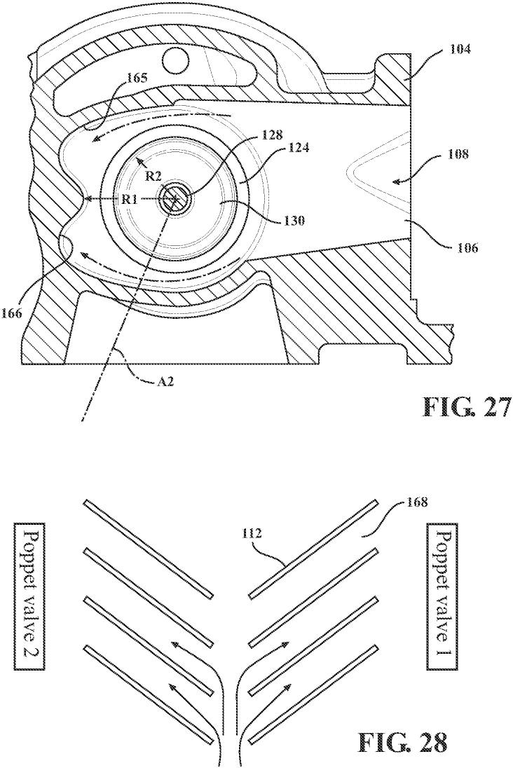

In another embodiment, as shown in FIGS. 27 and 28, the second interior radius R2 is greater than the first interior radius R1. The second interior surface 112 defines a first depression 165 and a second depression 166 spaced circumferentially from one another about the valve stem 128, and wherein the first and second depressions 165, 166 define the second interior radius R2 greater than the first interior radius R1. Having the first depression 165 and the second depression 166 defined by the second interior surface 112 reduces swirl of exhaust gas in the housing bore 114. The second interior surface 112 defining the first depression 165 and second depression 166 may include a plurality of contours 168, as shown in FIG. 28, configured to reduce swirl of the exhaust gas and to direct the flow of exhaust gas in the housing bore 114. For example, the plurality of contours 168 may have a Chevrons configuration and may be cast into the second interior surface 112.

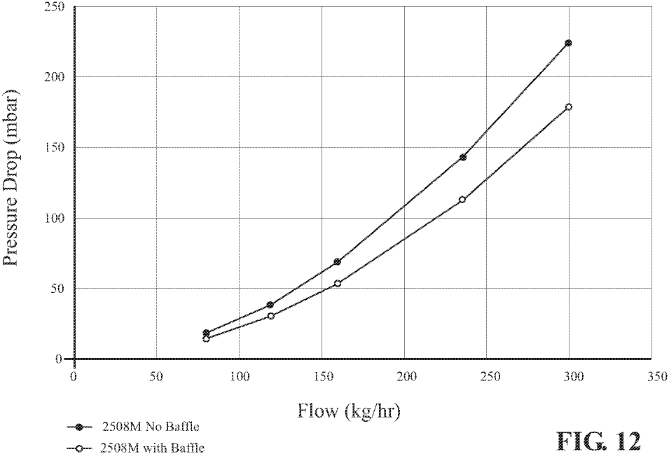

It is to be appreciated that each embodiment of the valve assembly 100 shown and described may be combined with any other embodiment of the valve assembly 100 shown and described. For example, the baffle 132 in the embodiments of FIGS. 6-10, FIGS. 12-16, FIGS. 17 and 18, FIG. 19, FIGS. 20A, 20B, and 24. FIGS. 21-23, FIG. 25, and FIG. 26.

What is claimed is:

1. A valve assembly for an exhaust gas recirculation system of an internal combustion engine, said valve assembly comprising:
a housing comprising,
a first interior surface defining an inlet bore extending along an inlet axis, wherein said inlet bore is configured to receive exhaust gas from the internal combustion engine,
a second interior surface defining a housing bore extending along a housing axis that is perpendicularly oriented with respect to said inlet axis, wherein said housing bore is fluidly coupled to said inlet bore for receiving the exhaust gas from said inlet bore, and
a third interior surface defining an outlet bore extending along an outlet axis, wherein said outlet bore is fluidly coupled to said housing bore for discharging exhaust gas from said housing bore;
a valve seat disposed in said housing bore;
a valve disposed in said housing bore and comprising a valve stem extending along said housing axis and a valve sealing member coupled to and moveable with said valve stem along said housing axis, wherein said valve is movable along said housing axis in said housing bore between a first position for allowing exhaust gas to flow from said inlet bore through said housing bore and into said outlet bore, and a second position different from said first position for restricting exhaust gas flow from said inlet bore through said housing bore and into said outlet bore; and
optionally, a baffle at least partially disposed in said housing bore;
wherein a first interior radius is defined between said valve stem and said second interior surface;
wherein a second interior radius is defined between at least one of said valve stem and said second interior surface, said valve stem and said baffle, and said baffle and said second interior surface; and
wherein said second interior radius is different from said first interior radius and configured to direct the flow of the exhaust gas in said housing bore to reduce swirl of exhaust gas in said housing bore.

2. The valve assembly as set forth in claim 1, wherein said second interior radius is less than said first interior radius.

3. The valve assembly as set forth in claim 1 further comprising said baffle, and wherein said second interior radius is defined between said valve stem and said baffle.

4. The valve assembly as set forth in claim 3, wherein said baffle comprises a base arm coupled to said housing, and a projecting arm extending into said housing bore, and wherein said second interior radius is defined between said valve stem and said projecting arm.

5. The valve assembly as set forth in claim 4, wherein said base arm is disposed in said inlet bore and said projecting arm is disposed in said housing bore.

6. The valve assembly as set forth in claim 4, wherein said projecting arm extends orthogonally from said base arm.

7. The valve assembly as set forth in claim 3, wherein said baffle is disposed in said housing bore.

8. The valve assembly as set forth in claim 7 further comprising a second baffle disposed in said housing bore and circumferentially spaced from said baffle about said valve stem.

9. The valve assembly as set forth in claim 8 further comprising a third baffle, wherein said first, second, and third baffles are circumferentially spaced from one another about said valve stem.

10. The valve assembly as set forth in claim 7, wherein said baffle is coupled to and extends from said valve seat in said housing bore.

11. The valve assembly as set forth in claim 7, wherein said baffle comprises a base portion coupled to said second interior surface, and a first baffle arm and a second baffle arm extending from said base portion toward said valve stem.

12. The valve assembly as set forth in claim 1, wherein said baffle is coupled to said valve stem and extends from said valve stem toward said second interior surface, and wherein said second interior radius is defined between said baffle and said second interior surface.

13. The valve assembly as set forth in claim 12, wherein said baffle comprises a first and second stem arms extending from said valve stem toward said second interior surface.

14. The valve assembly as set forth in claim 12 further comprising a second baffle extending from said second interior surface toward said valve stem.

15. The valve assembly as set forth in claim 2, wherein a ratio of said second interior radius to said first interior radius is between 0.1 to 1 and 0.9 to 1.

16. The valve assembly as set forth in claim 1, wherein said valve is further defined as a poppet valve, and further comprising a second valve sealing member coupled to said valve stem and spaced axially from said valve sealing member with respect to said valve stem.

17. The valve assembly as set forth in claim 16 further comprising a second valve seat spaced from said first valve seat along said housing axis, wherein said second valve sealing member allows exhaust gas to flow from said inlet bore through said housing bore and into said outlet bore when said valve is in said first position, and wherein said second valve sealing member restricts exhaust gas flow from said inlet bore through said housing bore and into said outlet bore when said valve is in said second position.

18. The valve assembly as set forth in claim 17, wherein said first valve seat and said second valve seat face away from one another with respect to said valve stem.

19. The valve assembly as set forth in claim 1, further comprising an actuator coupled to said housing, and wherein said actuator is coupled to said valve stem for moving said valve between said first and second positions.

20. An exhaust gas recirculation system comprising said valve assembly as set forth in claim 1 further comprising an intake manifold coupled to said housing and fluidly coupled to said inlet bore for delivering exhaust gas from the internal combustion engine, and further comprising an exhaust manifold coupled to said housing and fluidly coupled to said outlet bore for delivering exhaust gas to the internal combustion engine.
